(19) United States
(12) Patent Application Publication
(10) Pub. No.: US 2005/0030239 A1
(43) Pub. Date: Feb. 10, 2005

(54) Antenna of small dimensions

(75) Inventors: Ayoub Annabi, Dole (FR); Roland Vincent, Dole (FR); Daniel Leclerc, Crissey (FR)

Correspondence Address: BLANK ROME LLP, 600 NEW HAMPSHIRE AVENUE, N.W., WASHINGTON, DC, 20037, US

(73) Assignee: AMPHENOL SOCAPEX

(21) Appl. No.: 10/933,392

(22) Filed: Sep. 3, 2004

Related U.S. Application Data
(63) Continuation of application No. 10/263,072, filed on Oct. 3, 2002.

(30) Foreign Application Priority Data
Jul. 26, 2002 (FR) 02 09488
Aug. 21, 2002 (FR) 02 10434

(51) Int. Cl. H01Q 13/10

(52) U.S. Cl. 343/770; 343/767

(57) ABSTRACT

The invention relates to an antenna of small dimensions. According to an embodiment, the antenna comprises: a radiating element in the form of a plate; an antenna feed connected to the radiating element; a conductive surface substantially parallel to the radiating element and placed at a distance e from the element, the conductive surface being provided with at least one slot facing the radiating element; and a conductive connection between the conductive surface and the radiating element.

The present invention relates to an antenna of small dimensions for use particularly but not exclusively in a portable radiotelephone.

### BACKGROUND OF THE INVENTION

In portable radiotelephones, it is known to use helically-shaped antennas that are usually mounted outside the housing of the radiotelephone. Such antennas can be relatively small in size but they are located outside the housing in order to be associated with a ground plane that is located inside the housing of the radiotelephone.

A present trend in the manufacture of radiotelephones is to eliminate any external antenna and to place the antenna inside the housing. Another trend is also towards reducing the dimensions of the radiotelephone, or at least to integrating the largest possible number of components in a radiotelephone of given outside dimensions.

As a result, it is advantageous in terms of radiotelephone design for the antenna to satisfy two conditions: it should be internal, and it should be of dimensions that are relatively small.

In order to satisfy the first condition, proposals have been made to use patch antennas of the PiFa type or the like in radiotelephones. A patch antenna is essentially constituted by a ground plane and by a radiating plate, usually a radiating element extending parallel to the ground plane, and having a short-circuit connection between the radiating element and the ground plane, together with a 50 ohm (Ω) antenna feed that is usually implemented as a microstrip line or as a printed circuit.

Accompanying FIG. 1 is a simplified vertical section through such an antenna. It is constituted by a radiating element 10 of design that matches the wavelength(s) to be used and also the design impedance, which is typically 50 Ω. The antenna also has a ground plane 12 substantially parallel to the radiating element 10. A short circuit 14 is made between the radiating element 10 and the ground plane 12. Finally, the antenna is generally fed by means of a coaxial cable 16 whose central conductor 16a is electrically connected to the radiating element 10 and whose shielding 16b is connected to the ground plane. With such an antenna, it is necessary to provide a minimum spacing e in order to ensure that the antenna operates in satisfactory manner. Typically, the minimum spacing e is about 7 millimeters (mm) to 10 mm when the dielectric between the radiating element and the ground plane is air and when the frequency is less than 2 GHz.

Specifically, in the frequency range used for radiotelephones, and in particular in the frequency range that corresponds to the GSM system, which lies in the vicinity of 920 MHz, the minimum distance between the radiating element and the ground plane is about 7 mm to 10 mm when the dielectric between the radiating element and the ground plane is air. This thickness of about 7 mm to 10 mm is considered as being too large for making radiotelephones. Unfortunately, it has been found that if attempts are made to reduce the thickness of a PiFa antenna so as to bring it down to less than 5 mm, for example, then the passband of the antenna is considerably reduced, thus making it practically unusable. Conventional patch antennas therefore do not satisfy the second above-mentioned condition.

It should also be specified that in order to save space inside the radiotelephone, the metallization on the printed circuit board (PCB), i.e. the shielding etc., constitutes the ground plane of the radiotelephone, while the assembly constituted by the radiating element, the short circuit 14, and the feed cable 16 is mounted directly on the printed circuit.

There therefore exists a real need for antennas having a total thickness of not more than 5 mm while nevertheless presenting operating conditions that are acceptable and capable of functioning over a plurality of frequency bands corresponding to those conventionally used in radiotelephones, in computer modems, in particular for portable computers, in PCMCIA cards, in PDAs, etc. More generally, there exists a real need for antennas of small dimensions, i.e. of small volume.

### OBJECTS AND SUMMARY OF THE INVENTION

An object of the present invention is thus to provide a patch or coil antenna of small dimensions which nevertheless presents a passband complying with the standards presently in force, and suitable for being placed inside the housing of an appliance, for example a radiotelephone.

In a first aspect of the present invention, this object is achieved by a patch type antenna of small dimensions that is characterized in that it comprises:
a radiating element in the form of a plate;
an antenna feed connected to the radiating element;
a conductive surface substantially parallel to said radiating element and placed at a distance e from said element, said conductive surface being provided with at least one slot facing said radiating element; and
a conductive connection between said conductive surface and said radiating element.

The term “slot” should be understood as covering any recess in the conductive surface regardless of the shape of its outline.

In spite of its small thickness, e.g. about 3 mm, an antenna complying with the definition given above nevertheless makes it possible to obtain a passband that is suitable for use in a portable radiotelephone or the like operating in the commonly used frequency bands below 2 GHz, in particular in the GSM system. This result is obtained because, in addition to the electric field mainly created by the radiating element, a magnetic field is induced by the existence of the slot provided in the conductive surface facing the radiating element. Together these two fields in quadrature produce an electromagnetic wave corresponding to the wave used in an antenna of standard thickness, i.e. about 7 mm to 10 mm.

Preferably, the slot or at least one of said slots is open. Under such circumstances, radiation from the slot is avoided and the operation of the antenna is greatly improved.

The term “open slot” is used to cover a slot which opens out into the periphery of the conductive surface. In other words, when the slot is open, the slot is not completely surrounded by an electrically conductive element.

Also preferably, the shape of the preferably open slot is substantially identical to that of the radiating element.

In a preferred embodiment of the antenna, the conductive surface is constituted by a conductive plate, and the antenna further comprises an insulating mechanical structure on which the radiating element, the conductive plate, and the conductive connection are all fixed.

The assembly can be fixed directly on a printed circuit and connected in appropriate manner to the conductive tracks of the printed circuit.

In a second aspect of the present invention, the same object is achieved by a small volume antenna comprising a radiating element, said radiating element being constituted by coil-forming means forming a coil presenting an axis, said coil being connected to an antenna conductor, and the antenna further comprises a conductive element parallel to the axis of said coil with slot-forming means placed facing said coil-forming means.

It will be understood that in this second aspect of the invention, the antenna is constituted by coil-forming means of axis parallel to a conductive element facing the coil-forming means and provided with a slot or a disposition analogous to a slot.

As explained in greater detail below, this antenna disposition is of very small volume, being less than 5 mm thick, while nevertheless being capable of obtaining a passband that is satisfactory, in particular in the range of frequencies that correspond to the GSM system, which passband is much greater than the passband obtained using conventional antennas, said passband in said frequency range possibly being as great as 100 MHz to 120 MHz, and its gain being satisfactory.

In a preferred embodiment, the coil-forming means are constituted by a conductive wire in the form of a helical coil.

Tests have been performed which show that the coil may be small in diameter, e.g. having a diameter of about 3 mm, and the distance between the slotted conductive element and the axis of the coil can also be very small, being about 1.7 mm to 2 mm. This provides an antenna of total thickness less than 4 mm.

The coil-forming element may be a coil in the usual meaning, i.e. a helix made from a wire. The coil-forming element may also be a “flat” coil constituted by metallization on an insulating support.

The conducive element may be a conductive surface. In which case, the surface may be constituted by the ground plane of the antenna and the slot is closed, being substantially rectangular in shape corresponding to the apparent outline of the coil. It is also possible for the surface to be a conductive plate. In which case, the slot is open, i.e. it opens out into the periphery of the conductive surface.

The conductive element may also be a conductive element in the form of a wire. Under such circumstances, the wire is bent so as to present two substantially elongate portions defining the equivalent of a slot between them.

It is important to emphasize that in all embodiments of the invention, the antenna is constituted by a radiating element in the form of a plate or a coil connected to the antenna feed, and by a conducive element placed facing the radiating element and including slot-forming means. The conductive element may be a conductive surface provided with a slot or it may be a wire element folded to surround a space constituting the equivalent of a slot.

### BRIEF DESCRIPTION OF THE DRAWINGS

Other characteristics and advantages of the invention appear better on reading the following description of various embodiments of the invention given as non-limiting examples. The description refers to the drawings, in which:

FIG. 1, described above, shows a conventional antenna of the PiFa type;

FIG. 2A is a plan view of the conductive surface of a first embodiment of an antenna in accordance with the first aspect of the invention;

FIG. 2B is a plan view of the radiating element corresponding to FIG. 2A;

FIG. 2C is a vertical section view of the antenna incorporating the components of FIGS. 2A and 2B;

FIG. 3 is a graph plotting two curves corresponding to a reference antenna and to the antenna of FIGS. 2A to 2C;

FIG. 4 is a vertical section through a first variant of the antenna of FIGS. 2A to 2C;

FIG. 5 is a vertical section through a second variant of the antenna of FIGS. 2A to 2C;

FIG. 6A is a vertical section view of a first embodiment of an antenna in accordance with the second aspect of the invention;

FIG. 6B is a plan view of the antenna shown in FIG. 6A;

FIG. 7 is a view showing a first variant of the FIG. 6A antenna;

FIG. 8 is a fragmentary view of the FIG. 6A antenna showing a variant of the helical coil;

FIG. 9A is a vertical section view of a second embodiment of an antenna in accordance with the second aspect of the invention;

FIG. 9B is a detail view showing the special shape of the “flat” coils used in the FIG. 9A antenna;

FIGS. 10A and 10B show a second variant of the FIG. 6A antenna in vertical section and in plan view;

FIG. 11 is a vertical section view of a third embodiment in accordance with the second aspect of the invention; and

FIGS. 12A and 12B are respectively an elevation view and a plan view of an antenna in accordance with the second aspect of the invention and having a second embodiment of the conductive element.

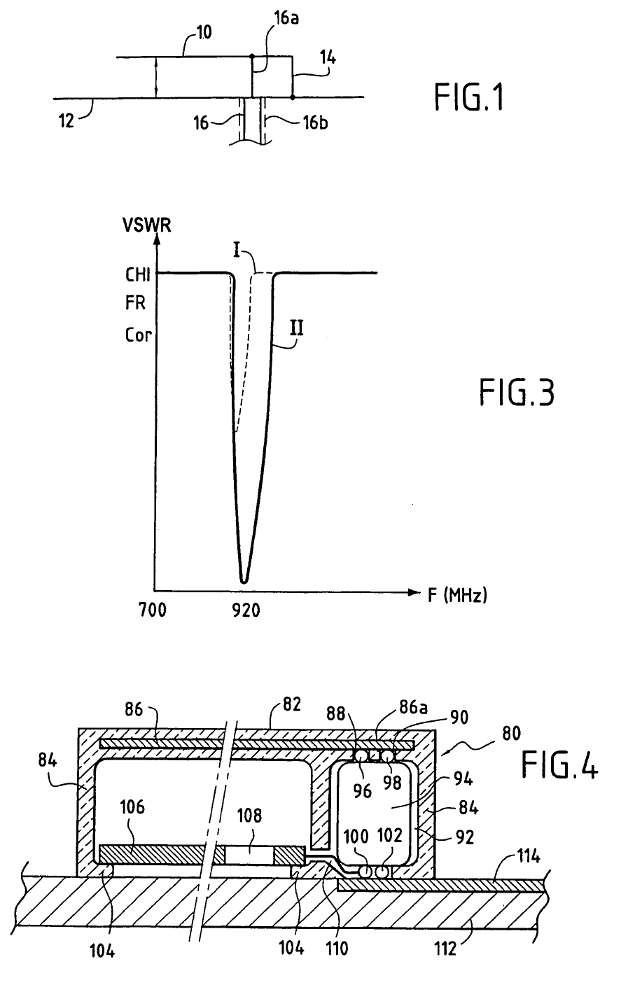

### MORE DETAILED DESCRIPTION

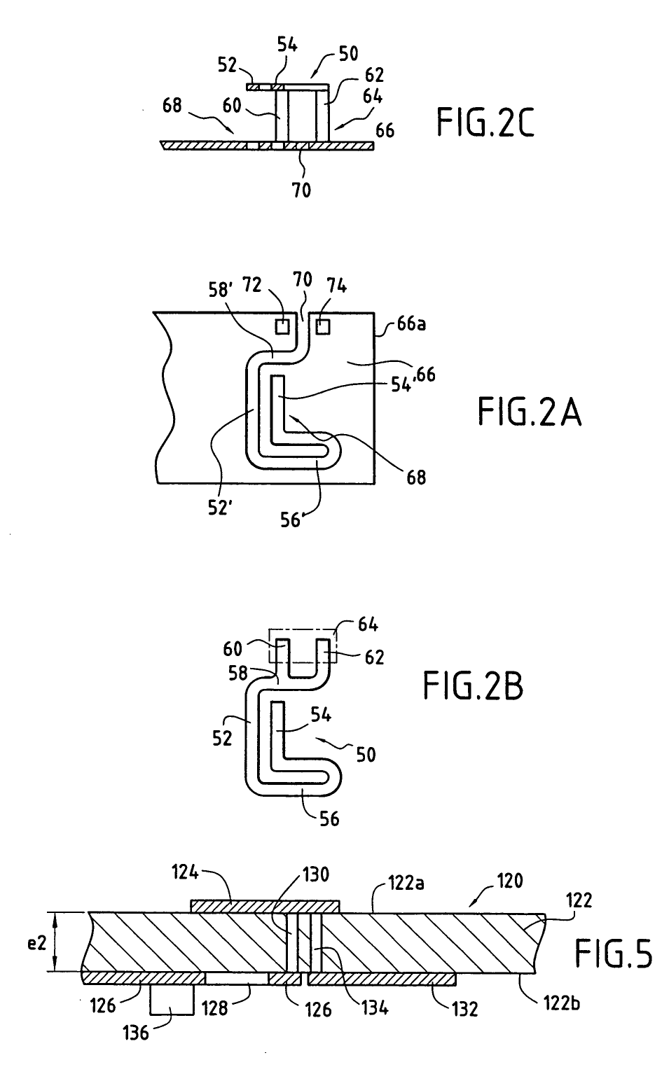

With reference to FIGS. 2A to 2C, there follows a description of a first embodiment of an antenna in accordance with the first aspect of the invention.

In this particular embodiment, as can be seen in FIG. 2B, the radiating element 50 is in the form of a plate and comprises two parallel main portions 52 and 54 that are united at one end by a loop 56 and that are extended at the opposite end of the rectilinear portion 52 by a branch 58. The shape of the radiating element is defined by the operating frequency(ies) of the antenna and by the desired impedance. The branch 58 is extended by two connection tabs 60 and 62 respectively for the antenna feed and for the short circuit, which tabs are fixed to a dual connection element 64. Other shapes could be used for the radiating element.

FIG. 2A shows a conductive surface 66 with its slot 68 whose outline is close to that of the radiating element 50, but is not necessarily identical thereto. The slot is constituted by slot portions 52′, 54′, 56′, and 58′. The branch 58′ of the slot is extended by a portion 70 which opens out into the periphery 66a of the conductive surface 66. The portion 70 is disposed between connection areas 72 and 74 corresponding respectively to establishing an electrical short circuit between the radiating element and the conductive surface 70, and to feeding the antenna. The dual connection 64 also constitutes means for mechanically fixing the radiating element to the conductive surface so as to hold said radiating element parallel to the conductive surface at a distance e₁ therefrom of about 2 mm, and in any event less than 5 mm.

The conductive surface 66 may be constituted by a conductive plate or by metallization on an insulating substrate.

FIG. 3 shows firstly a curve I giving the standing wave ratio (SWR) of a reference antenna as a function of frequency F, and a curve II showing the voltage standing wave ratio (VSWR) of the antenna of FIGS. 2A to 2C as a function of frequency. The reference antenna corresponding to curve I is an antenna identical to that shown in FIGS. 2A to 2C except that the conductive surface 66 forms a ground plane without the slot 68.

FIG. 3 shows clearly that the reference antenna corresponding to the curve I presents a passband that is much smaller and with amplification that is much smaller than the antenna constituting the subject matter of the invention which corresponds to curve II.

With reference to FIG. 4, a first variant of the antenna in accordance with the first aspect of the invention is described. In this variant, the structure of the antenna proper is identical to that described above, however a mechanical structure is added thereto in order to make the antenna modular. The mechanical structure is made of an insulating material, preferably a moldable plastics material, it is given overall reference 80, and its general shape is that of a cap having a top wall 82 and four side walls such as 84. The radiating element shown in simplified manner at 86 is preferably embedded within the plastics material constituting the top wall 82. It may have the shape shown in FIG. 2B. Facing the portion 86a of the radiating element, the top wall 82 has connection recesses 88 and 90. In addition, the mechanical structure 80 defines a housing 92 in which a dual connection member 94 can be clipped or mounted in any other suitable way. This member 94 serves to provide the antenna feed connection and the short circuit connection. For this purpose, the connection member 94 has two top contacts 96 and 98 that penetrate into the recess 88 and 90, and two bottom contacts 100 and 102.

The bottom portions of the side walls 84 of the cap 80 have rims 104 of increased thickness for fixing to the periphery of a conductive plate 106 constituting the conductive surface. The slot(s) 108 made in the plate 106 are shown in simplified manner. In addition, the plate 106 has a flexible contact 110 which penetrates into the housing 92 to provide an electrical connection with the short circuit contact 102, and thus a connection with the radiating element.

FIG. 4 also shows a portion of a printed circuit 112 having conductive tracks 114 constituting firstly an electrical ground and secondly the antenna conductor. These conductive tracks 114 are connected to the electrical contacts 100 and 102 of the connection element 94.

It will be understood that the assembly constituted by the cap 80 with its connection element 94 can be fixed directly on the surface of the printed circuit 112 so as to establish the above-mentioned electrical connections and so as to secure the cap mechanically on the printed circuit. Naturally, in this embodiment, the distance e₁ between the radiating element 86 and the conductive plate 106 is about 2 mm.

FIG. 5 shows a second variant of an antenna in accordance with the first aspect of the invention. The antenna is made as a printed circuit 120. In this figure, there can be seen the insulating substrate 122 of the printed circuit which is of a thickness e₂ of about 2 mm. On a first face 122a of the insulating substrate 122, there is first metallization 124 defining the radiating element which can be of the shape shown in FIG. 2B, for example. Second metallization 126 is formed on the second face 122b of the insulating substrate 122 to constitute the conductive surface of the antenna. This conductive surface is naturally provided with one or more slots 128 facing the radiating element 124 and of outline substantially identical to that of the radiating element. The short circuit is established via a first plated-through hole 130 passing through the insulating substrate 122 and connected to the metallization 126. A second plated-through hole 134 provides a connection between the radiating element 124 and an antenna conductor 132 on the face 122b of the insulating substrate 122.

This provides an antenna having exactly the same characteristics as those described above, except that the dielectric between the radiating element 124 and the conductive surface 126 is no longer air, but is rather the material from which the insulating substrate 122 of the printed circuit is made.

In order to improve the performance of the antenna, it is possible to mount one or more passive inductor and/or capacitor components on the conductive surface 126.

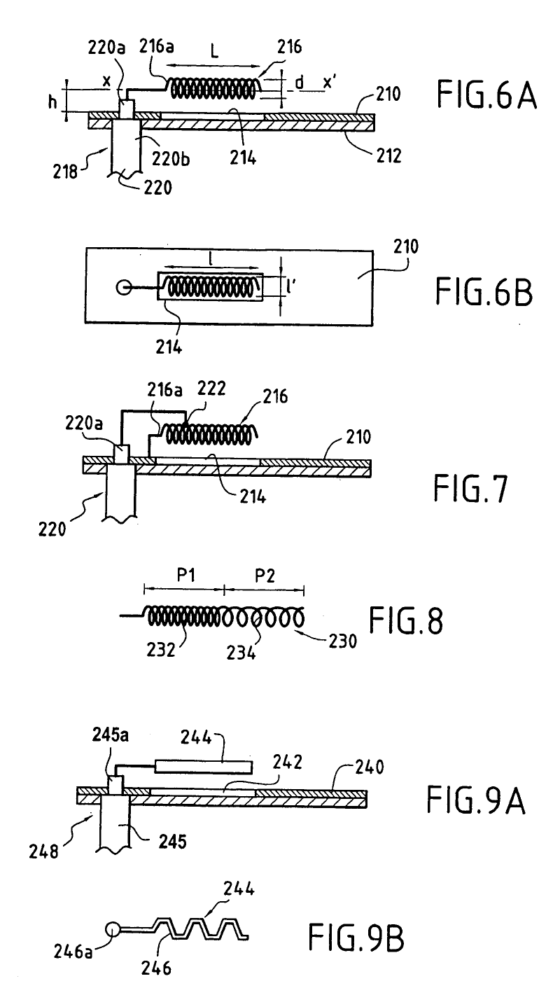

Reference is made below to FIGS. 6A and 6B in order to describe a preferred first embodiment of an antenna in accordance with the second aspect of the invention.

The antenna comprises a ground plane 210 constituted by an electrically conductive material, e.g. mounted or placed on an insulating support 212. As can be seen more clearly in FIG. 6B, a slot 214 is made in the ground plane 210 having a shape that is described in greater detail below. The antenna also comprises a radiating element constituted by a helical coil 216 whose axis x-x′ is parallel to the ground plane 210. One of the ends 216a of the coil 216 is connected to the antenna feed 218 which is constituted by a coaxial cable 220, for example, having its central conductor 220a connected electrically to the end 216a of the coil and having its shielding 220b connected to the ground plane 210. The coil 216 is of length L and of diameter d.

FIG. 6B shows in greater detail the particular shape of the slot 214 made in the ground plane 210. This slot 214 is in the form of a rectangle following the outline of the coil 216. In other words, the rectangular slot 214 is of length l which is substantially equal to the length L of the coil and of width l′ substantially equal to the diameter d of the coil 216. This slot is closed, i.e. it does not open out into the periphery of the ground plane.

In a particular embodiment, the diameter d of the coil 216 is equal to 3 mm and the distance h between the ground plane 210 and the axis x-x′ of the coil 216 is equal to 1.72 mm.

In order to obtain a given impedance for the antenna, typically an impedance of 50 Ω, the distance h between the coil and the ground plane and the diameter a of the wire constituting said coil are associated by the following equation:

$${Z}_{0} = \frac{138}{\sqrt{{ɛ}_{r}}} {Log}_{10} ( \frac{4 h}{a} )$$

In this formula, εᵣ=1 for air and Z₀ is equal to 50 Ω.

In addition, in this embodiment, the length L of the coil is equal to 20 mm. The dimensions of the slot 214 are thus 20 mm by 3 mm.

Tests performed with the antenna as defined above have shown that for a frequency range corresponding to the GSM system, i.e. for a center frequency of about 920 MHz, a passband is obtained having a width of about 100 MHz to 120 MHz.

Not only is such a passband entirely acceptable for making a portable radiotelephone, it is also approximately twice the width of the band obtained using antennas of the PiFa type, for example.

It should be emphasized that the total thickness of the antenna is small since in the example concerned this thickness is less than 3.5 mm, and that the antenna is also relatively simple to make, particularly because of the rectangular shape of the slot 214 to be made in the ground plane.

FIG. 7 shows a first variant of this first embodiment in which the coil 216 is fed in different manner by the antenna cable 220. The axial conductor of the cable 220a is connected to a point 222 along the length of the coil 216 whereas the end 216a of the coil is connected to the ground plane 210. This provides a “shunt” feed to the antenna, thus making it possible to obtain an impedance that corresponds to a choke component.

FIG. 8 shows a variant of the coil 216, given a new reference 230. This coil comprises a first portion 232 whose turns are at a first pitch P1 and a second portion 234 whose turns are at a pitch P2 different from P1. In addition, the helical antenna has a constant diameter d. Tests performed with this type of helical coil have shown that the antenna operates effectively in two or three frequency bands that are defined by suitably selecting the pitches P1 and P2 for the two portions of the helical coil.

With reference to FIGS. 9A and 9B, there follows a description of a second variant of the antenna. In this variant, there is a ground plane 240 provided with a closed slot 242 and a radiating element 244 constituted by a flat coil 244 as shown in FIG. 9B. The flat coil 244 is constituted by a zigzag-shaped flat conductive element 246. The end 246a of the flat antenna 244 is connected to the antenna conductor 248 which is constituted by the coaxial cable 245. More precisely, the end 246a is connected to the central conductor 245a of the cable 245.

Tests performed with this second variant of the antenna have also given results that are satisfactory, even though not as good as those obtained with the first variant of the antenna.

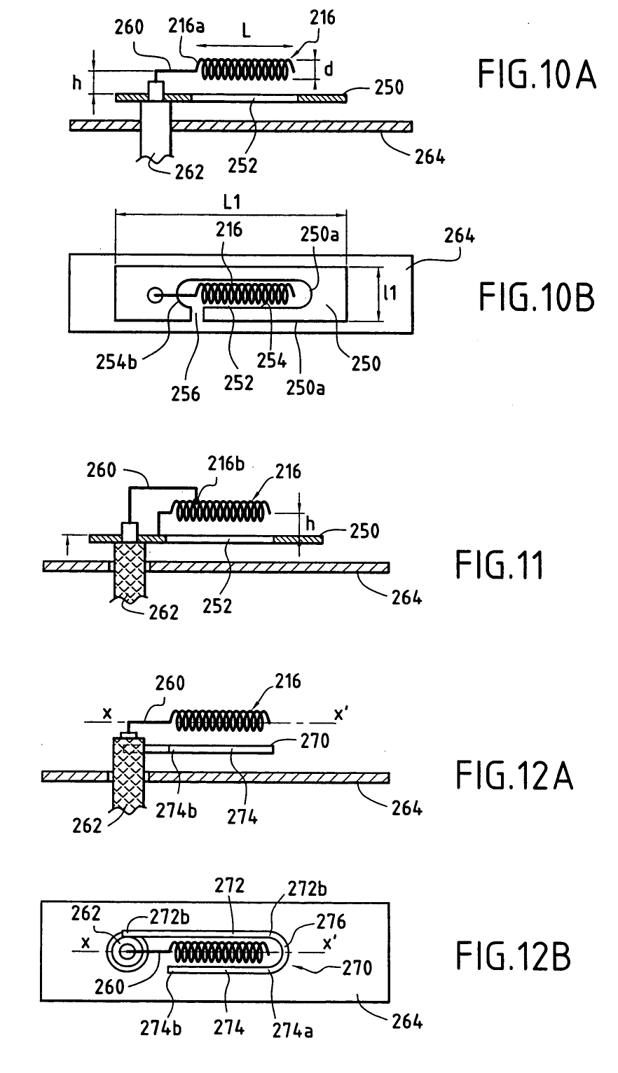

With reference to FIGS. 10A and 10B, there follows a description of a second embodiment of an antenna in accordance with this aspect of the invention. This second embodiment differs from the first essentially in that the conductive surface in which the slot is formed is not the ground plane of the antenna, but is instead a conductive plate.

These figures show a coil 216 that may be identical to the coil shown in FIG. 6A or in FIG. 8. The antenna also has a conductive plate 250 which is parallel to the axis x-x′ of the coil 216. The distance h between the axis of the coil and the plate is the same as in FIG. 6A. This plate is not connected electrically to any other component of the antenna.

The plate 250 is provided with a slot 252 of outline 254 corresponding to the shape of the coil. The outline 254 may be generally rectangular in shape with two short sides constituted by semicircles 254a and 254b. It can be shown with this embodiment, that in order to ensure that the antenna presents acceptable gain, it is necessary for the slot 252 to open out into the periphery 250a of the plate 250 via an extension 256. The plate may be of length L1 equal to 35 mm and of width equal to 9 mm, the coil having the dimensions mentioned above with reference to FIGS. 6A and 6B. The dimensions of the antenna are thus very small.

The end 216a of the coil is connected to the central conductor 260 of the coaxial feed cable 262. The plate 250 is electrically isolated from the conductor 260.

The antenna may be mounted on a printed circuit 264 of a portable radiotelephone or of any other appliance having an internal antenna. The shielding 262a of the cable 262 is connected to a suitable ground of the printed circuit.

This second embodiment provides performance that is the same as that obtained with the first embodiment. When used with a coil 16 having two different pitches, the antenna can operate both in the GSM frequency band and in the DCS frequency band.

FIG. 11 shows another embodiment of the antenna of the invention. In this embodiment, there can be seen the coil 216 and the conductive plate 250 with its open slot 252. The end 216a of the coil 216 is connected to the conductive plate 250 while the axial conductor 260 of the antenna cable is connected to an intermediate point 216b along the coil 216.

FIGS. 12A and 12B show an embodiment of the antenna in which the conductive element is not constituted by a conductive surface but instead by a conductive wire element 270. The wire preferably has a diameter of not less than 2.5 mm. It has two substantially rectilinear portions 272 and 274 that are substantially parallel to each other.

The first ends 272a, 274a of the rectilinear portions are connected together by a curved portion 276. The second end 272b of the portion 272 is electrically connected to the shielding of the coaxial cable 262, while the second end 274b of the portion 274 is free. This wire element 270 thus defines the equivalent of a slot 276. The two portions 272 and 274 of the wire element 270 are substantially coplanar and lie in a plane that is parallel to the axis x-x′ of the coil 216.

1. An antenna of small dimensions, comprising:
a single radiating element in the form of a plate;
a single antenna feed connected to the radiating element;
a conductive surface substantially parallel to said radiating element and placed at a distance e from said element, said conductive surface being provided with at least one slot facing said radiating element; and
a conductive connection between said conductive surface and said radiating element.

2. An antenna according to claim 1, in which said slot or at least one of said slots is open.

3. An antenna according to claim 2, in which said radiating element is of a specific shape and in which said slot or said slots are of a shape substantially identical to said specific shape of the radiating element.

4. An antenna according to claim 2, in which said conductive surface is constituted by a conductive plate.

5. An antenna according to claim 4, further comprising an insulating mechanical structure on which said radiating element, said conductive plate, and said conductive connection are all fixed.

6. An antenna according to claim 6, in which said mechanical structure is made of a moldable material, said structure having a top portion in which said structure having a top portion in which said radiating element is embedded.

7. An antenna according to claim 6, further comprising a connector component mounted on said mechanical structure to connect said radiating element electrically to the antenna feed and to form a short circuit between said radiating element and ground.

8. An antenna according to claim 7, in which said mechanical structure comprises at least two side walls having said conductive plate fixed thereto parallel to said radiating element.

9. An antenna according to claim 1, further comprising an insulating substrate of a printed circuit presenting a first face and a second face, and in which:
said radiating element is formed by first metallization formed on said first face of the substrate;
said conductor surface is formed by second metallization formed on said second face of the substrate; and
aid antenna feed and said conductive connection are constituted by electrical connections passing through said substrate.

10. An antenna according to claim 9, further comprising at least one passive inductor and/or capacitor component.

11. An antenna according to claim 1, in which the operating frequency of the antenna is less than 2 GHz.

12. An antenna of small dimensions comprising:
a radiating element constituted by coil-forming means forming a coil presenting an axis;
an antenna feed connected to said coil-forming means; and
a conductive element parallel to the axis of the coil-forming means, said conductive element comprising slot-forming means placed facing said coil-forming means.

13. An antenna according to claim 12, in which said coil-forming means are constituted by a conductive wire shaped to form a helical coil.

14. An antenna according to claim 13, in which said conductive element is a conductive surface, and said slot-forming means are constituted by a slot made in said conductive surface.

15. An antenna according to claim 14, in which aid conductive surface is the ground plane of the antenna.

16. An antenna according to claim 14, in which said conductive surface is a conductive plate presenting a periphery, and said slot opens out into the periphery of said plate.

17. An antenna according to claim 15, in which said slot is rectangular in shape having one side of length substantially equal to the diameter of the coil and having its other side of length substantially equal to the length of the coil.

18. An antenna according to claim 15, in which said antenna conductor is connected to one end of the coil.

19. An antenna according to claim 15, in which one of the ends of the coil is electrically connected to the ground plane and the antenna conductor is connected to an intermediate point along the coil.

20. An antenna according to claim 13, in which said conductive element is a wire element folded to form two main portions that are substantially parallel to each other, each main portion having a first end connected to the first end of the other main portion, the slot-forming means being constituted by the space defined by the two main portions.

21. An antenna according to claim 20, in which said two main portions of the wire element are disposed substantially in a common plane parallel to the axis of the coil.

22. An antenna according to claim 13, in which said helically-shaped coil comprises a first portion presenting a first pitch and a second portion presenting a second pitch distinct from the first pitch.

23. An antenna according to claim 16, in which said slot is substantially rectangular in shape, having one side of length substantially equal to the diameter of aid coil and having its other side of length substantially equal to the length of the coil.

24. An antenna of small dimensions, comprising:
a single radiating element in the form of a plate;
a single antenna feed connected to the radiating element;
a conductive surface substantially parallel to said radiating element and placed at a distance e from said element, said conductive surface being provided with at least one slot facing said radiating element; and
a conductive connection between said conductive surface and said radiating element; wherein
said slot or at least one of said slots is open; and wherein
said radiating element is of a specific shape and in which said slot or said slots are of a shape substantially identical to said specific shape of the radiating element.

25. An antenna of small dimensions for working in a GSM system, comprising:
a single radiating element in the form of a plate;
a single antenna feed connected to the radiating element;
a conductive surface substantially parallel to said radiating element and placed at a distance e from said element, said distance e being less than 3 mm, said conductive surface being provided with at least one slot facing said radiating element; and
a conductive connection between said conductive surface and said radiating element.

26. An antenna of small dimensions for transmitting and receiving radio-frequency signals, comprising:
a single radiating element in the form of a plate;
a conductive surface substantially parallel to said radiating element and placed at a distance e from said radiating element, wherein said distance is less than 3 mm;
said conductive surface being provided with at least one slot facing radiating element;
a single antenna feed connected to the radiating element;
a conductive connection between said conductive surface and said radiating element;
the conductive connections between said conductive surface and said radiating element being connected to the conductive surface within the edges of said at least one slot.
